(19) United States
(12) Patent Application Publication
(10) Pub. No.: US 2002/0002916 A1
(43) Pub. Date: Jan. 10, 2002

(54) Printing press

(76) Inventor: Hiroyuki Sugiyama, Toride-shi (JP)

Correspondence Address: BIRCH STEWART KOLASCH & BIRCH, PO BOX 747, FALLS CHURCH, VA, 22040-0747, US

(21) Appl. No.: 09/783,990

(22) Filed: Feb. 16, 2001

(30) Foreign Application Priority Data
Feb. 16, 2000 (JP) 2000-37707

(51) Int. Cl. B41F 9/00

(52) U.S. Cl. 101/142

(57) ABSTRACT

A printing press comprises first to fourth offset printing units for offset printing a sheet, and a screen printing unit for screen printing the sheet. The first to fourth offset printing units and the screen printing unit are connected together so that offset printing and screen printing can be continuously performed on the same sheet efficiently.

### BACKGROUND OF THE INVENTION

1. Field of the Invention

This invention relates to a printing press which can efficiently perform both of offset printing and screen printing on the same sheet-like material.

2. Description of the Related Art

To perform both of offset printing and screen printing on the same sheet-like material, the sheet-like material is printed by a printing press using one of the printing methods, and then the sheet-like material is transferred to a printing press using the other printing method, and printed thereby. Execution of these two types of printing on the same sheet-like material requires much labor for transfer and registration of the sheet-like material, resulting in poor operation efficiency.

### SUMMARY OF THE INVENTION

The present invention has been accomplished to solve the above-described problem. It is an object of the invention to provide a printing press which can efficiently perform both of offset printing and screen printing on the same sheet-like material.

According to the present invention, there is provided a printing press comprising an offset rotary printing unit for offset printing a sheet-like material, and a rotary screen printing unit for screen printing the sheet-like material, and wherein the offset rotary printing unit and the rotary screen printing unit are connected together so that offset printing and screen printing can be continuously performed on the same sheet-like material.

In the above printing press, the rotary screen printing unit may include a rotatable impression cylinder having a gripper for holding the sheet-like material, and a rotatable rotary screen contacting the impression cylinder for screen printing the sheet-like material held on the impression cylinder, and wherein a rotatable transfer cylinder may connect the impression cylinder of the rotary screen printing unit to the offset rotary printing unit, the diametrical dimension of the impression cylinder of the rotary screen printing unit may be set such that the gripper of the impression cylinder is buried inwardly of the outer peripheral surface of the impression cylinder when the gripper holds the sheet-like material, and the diametrical dimension of the transfer cylinder may be set such that the sheet-like material can be transferred between the impression cylinder of the rotary screen printing unit and the offset rotary printing unit.

In the above printing press, the rotary screen printing unit may include a rotatable impression cylinder having sheet-like material holding means for holding the sheet-like material, and a rotary screen contacting the impression cylinder for screen printing the sheet-like material held on the impression cylinder, and wherein the sheet-like material holding means of the impression cylinder of the rotary screen printing unit may comprise suction holding means for sucking and holding the sheet-like material.

In the printing press, the suction holding means may include a suction holding implement provided in a gap of the outer peripheral surface of the impression cylinder, and having a suction port on the surface of the suction holding implement, suction means connected to the suction holding implement, and switching means provided between the suction holding implement and the suction means and adapted to establish communication between the suction holding implement and the suction means when receiving the sheet-like material and block communication between the suction holding implement and the suction means when transferring the sheet-like material.

In the printing press, a plurality of the suction holding implements may be provided along the axial direction of the impression cylinder, and opening/closing means for opening and closing the suction port of the suction holding implement may be provided for each of the suction holding implements.

In the printing press according to the present invention, the offset rotary printing unit and the rotary screen printing unit are connected together so that offset printing and screen printing can be continuously performed on the same sheet-like material. Thus, transfer of the sheet-like material between offset printing and screen printing, and registration of the sheet-like material in each of these types of printing become unnecessary, so that the operation efficiency can be increased.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is an overall schematic configuration view of a first embodiment of a printing press according to the present invention;

FIG. 2 is an extracted enlarged view of a portion indicated by an arrow II in FIG. 1;

FIG. 3 is an extracted enlarged view of a portion indicated by an arrow III in FIG. 1;

FIG. 4 is an extracted enlarged view of a portion indicated by an arrow IV in FIG. 3;

FIG. 5 is an extracted enlarged view of a portion indicated by an arrow V in FIG. 3;

FIG. 6 is an overall schematic configuration view of another example of the first embodiment of the printing press according to the present invention;

FIG. 7 is an overall schematic configuration view of still another example of the first embodiment of the printing press according to the present invention;

FIG. 8 is an overall schematic configuration view of a further example of the first embodiment of the printing press according to the present invention;

FIG. 9 is an overall schematic configuration view of a still further example of the first embodiment of the printing press according to the present invention;

FIG. 10 is an overall schematic configuration view of an additional example of the first embodiment of the printing press according to the present invention;

FIG. 11 is an overall schematic configuration view of a second embodiment of a printing press according to the present invention;

FIG. 12 is an extracted enlarged view of a portion indicated by an arrow XII in FIG. 11;

FIG. 13 is an extracted enlarged view of an end portion of a shaft of an impression cylinder of a screen printing unit;

FIG. 14 is a sectional view of FIG. 13;

FIG. 15 is a view taken from the direction of an arrow XV in FIG. 14;

FIG. 16 is a sectional view taken on line XVI-XVI in FIG. 14;

FIG. 17 is a sectional view taken on line XVII-XVII in FIG. 14;

FIG. 18 is an extracted enlarged view of a portion indicated by an arrow XVIII in FIG. 12;

FIG. 19 is a view taken from the direction of an arrow XIX in FIG. 18;

FIG. 20 is an internal structure view of a portion indicated by an arrow XX in FIG. 19;

FIG. 21 is an overall schematic configuration view of another example of the second embodiment of the printing press according to the present invention; and

FIG. 22 is an overall schematic configuration view of still another example of the second embodiment of the printing press according to the present invention.

### DESCRIPTION OF THE PREFERRED EMBODIMENTS

Preferred embodiments of the present invention will now be described in detail with reference to the accompanying drawings, but they in no way limit the invention.

[First Embodiment]

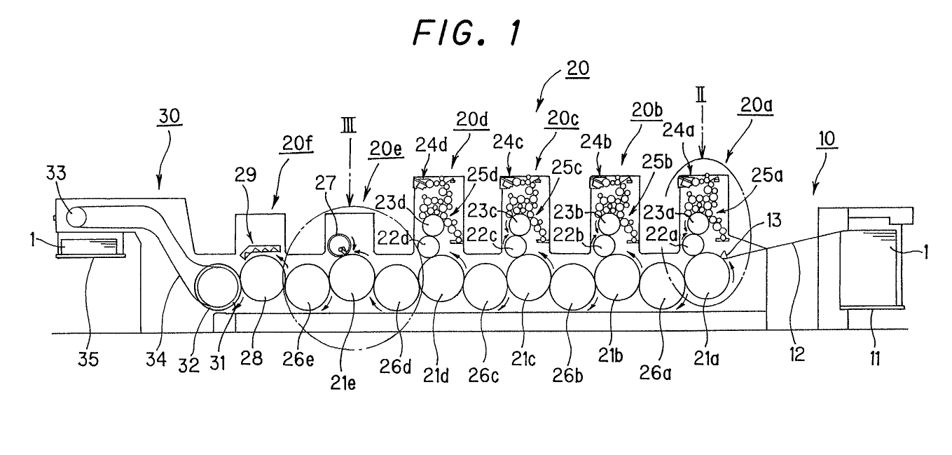

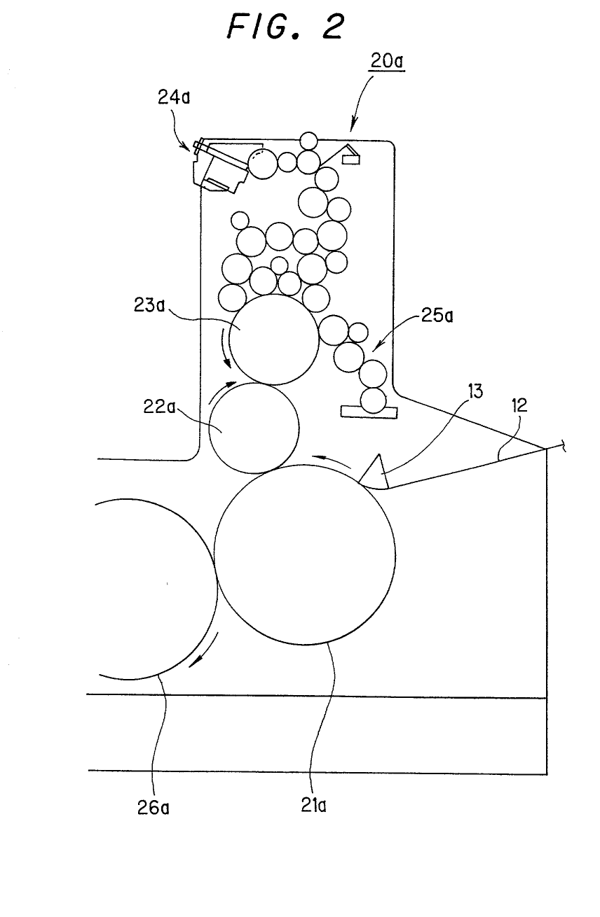

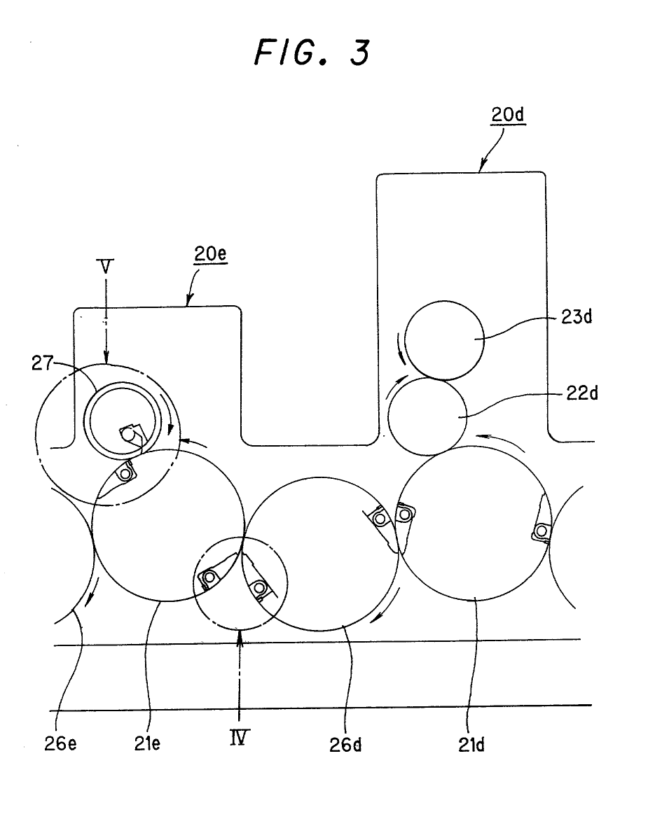

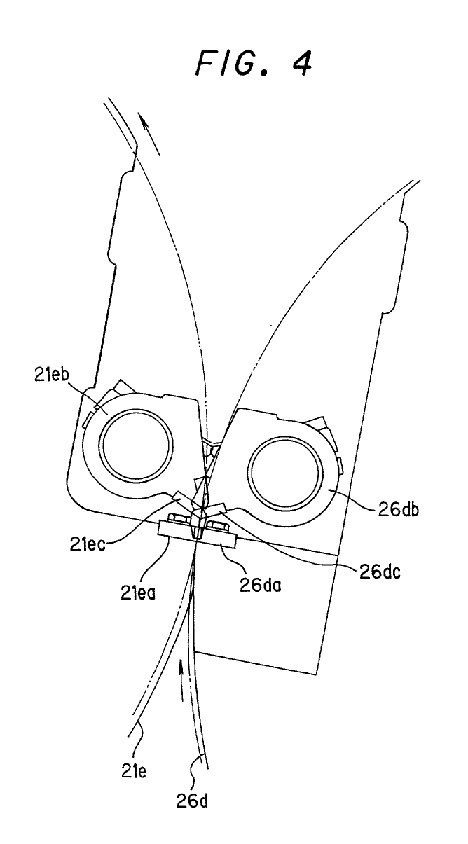

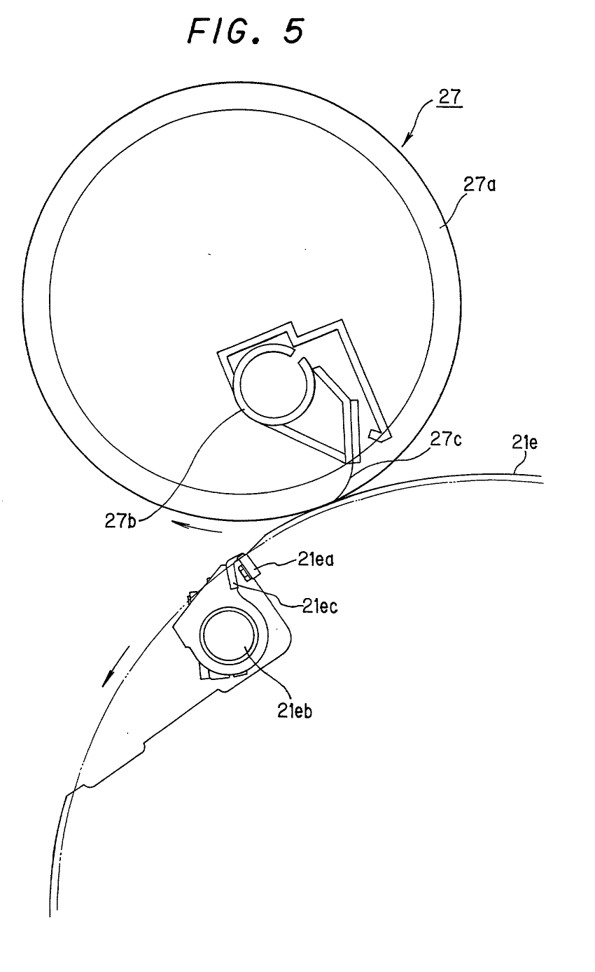

A first embodiment of a printing press according to the present invention will be described using FIGS. 1 to 5. FIG. 1 is an overall schematic configuration view of the printing press. FIG. 2 is an extracted enlarged view of a portion indicated by an arrow II in FIG. 1. FIG. 3 is an extracted enlarged view of a portion indicated by an arrow III in FIG. 1. FIG. 4 is an extracted enlarged view of a portion indicated by an arrow IV in FIG. 3. FIG. 5 is an extracted enlarged view of a portion indicated by an arrow V in FIG. 3.

As shown in FIG. 1, a feeder stand 11 is provided in a feeder unit 10. The feeder unit 10 is provided with a feeder board 12 for feeding sheet-like materials, i.e., sheets 1, on the feeder stand 11 one by one to a printing unit 20. A swing arm shaft pregripper 13 for passing the sheet 1 on to an impression cylinder 21a of a first offset printing unit 20a of the printing unit 20 is provided at a front end of the feeder board 12.

As shown in FIGS. 1 and 2, a blanket cylinder 22a contacts a portion of the impression cylinder 21a of the first offset printing unit 20a of the printing unit 20 downstream from the swing arm shaft pregripper 13 in the rotating direction of the impression cylinder 21a. A plate cylinder 23a contacts a portion of the blanket cylinder 22a upstream from the impression cylinder 21a in the rotating direction of the blanket cylinder 22a. An inking device 24a is provided upstream from the blanket cylinder 22a in the rotating direction of the plate cylinder 23a. A dampening device 25a is provided upstream from the inking device 24a in the rotating direction of the plate cylinder 23a.

As shown in FIG. 1, a portion of the impression cylinder 21a of the first offset printing unit 20a downstream from the blanket cylinder 22a in the rotating direction of the impression cylinder 21a contacts an impression cylinder 21b of a second offset printing unit 20b via a transfer cylinder 26a. The second offset printing unit 20b, like the first offset printing unit 20a, includes a blanket cylinder 22b, a plate cylinder 23b, an inking device 24b, and a dampening device 25b.

A portion of the impression cylinder 21b of the second offset printing unit 20b downstream from the blanket cylinder 22b in the rotating direction of the impression cylinder 21b contacts an impression cylinder 21c of a third offset printing unit 20c via a transfer cylinder 26b. The third offset printing unit 20c, like the first and second offset printing units 20a and 20b, includes a blanket cylinder 22c, a plate cylinder 23c, an inking device 24c, and a dampening device 25c.

A portion of the impression cylinder 21c of the third offset printing unit 20c downstream from the blanket cylinder 22c in the rotating direction of the impression cylinder 21c contacts an impression cylinder 21d of a fourth offset printing unit 20d via a transfer cylinder 26c. The fourth offset printing unit 20d, like the first to third offset printing units 20a to 20c, includes a blanket cylinder 22d, a plate cylinder 23d, an inking device 24d, and a dampening device 25d. These first to fourth offset printing units 20a to 20d constitute an offset rotary printing unit in the present embodiment.

As shown in FIGS. 1 and 3, a transfer cylinder 26d contacts a portion of the impression cylinder 21d of the fourth offset printing unit 20d downstream from the blanket cylinder 22d in the rotating direction of the impression cylinder 21d. Only the diametrical dimension of the transfer cylinder 26d is smaller than that of the other transfer cylinders 26a to 26c by a predetermined value. An impression cylinder 21e of a screen printing unit 20e as a rotary screen printing unit contacts a portion of the transfer cylinder 26d downstream from the impression cylinder 21d in the rotating direction of the transfer cylinder 26d. Only the diametrical dimension of the impression cylinder 21e is larger than that of the other impression cylinders 21a to 21d by a predetermined value.

That is, as shown in FIG. 4, the distance between a gripper pad 21ea and the cylinder axis, the distance between a gripper holder 21eb and the cylinder axis, and the distance between a gripper 21ec and the cylinder axis in the impression cylinder 21e of the screen printing unit 20e are the same as those in the other impression cylinders 21a to 21d of an ordinary size. However, the distance between the outer peripheral surface (effective impression area) of the impression cylinder 21e and the axis of the cylinder (accordingly, the diametrical dimension) is set to be greater than that of the other impression cylinders 21a to 21d of an ordinary size (the size indicated by two-dot chain lines in FIGS. 4 and 5) so that when the gripper 21ec is closed (i.e., when the gripper 21ec holds the sheet 1), the gripper 21ec is buried inwardly of the outer peripheral surface of the impression cylinder 21e. On the other hand, the distance between a gripper pad 26da and the axis, the distance between a gripper holder 26db and the axis, and the distance between a gripper 26dc and the axis in the transfer cylinder 26d are the same as those in the other transfer cylinders 26a to 26c of an ordinary size. However, the distance between the outer peripheral surface of the transfer cylinder 26d and the axis of the cylinder (accordingly, the diametrical dimension) is set to be smaller than the other transfer cylinders 26a to 26c of an ordinary size (the size indicated by two-dot chain lines in FIG. 4) so that the transfer cylinder 26d does not interfere with the outer peripheral surface of the impression cylinder 21e, in other words, the transfer cylinder 26d can transfer the sheet 1 to the impression cylinder 21e. Thus, the sheet 1 can be transferred, without problems, between the impression cylinder 21d of the fourth offset printing unit 20d and the transfer cylinder 26d. Furthermore, the sheet 1 can be transferred, without problems and without interference, between the transfer cylinder 26d and the impression cylinder 21e of the screen printing unit 20e.

As shown in FIGS. 1 and 5, a rotary screen 27 contacts a portion of the impression cylinder 21e of the screen printing unit 20e downstream from the transfer cylinder 26d in the rotating direction of the impression cylinder 21e. The rotary screen 27 includes a hollow cylinder 27a comprising a rotatably supported cylindrical thin screen of stainless steel, nickel or the like having small holes corresponding to a pattern etched therein, and an ink fountain 27b and a squeegee 27c fixed to and supported by a frame inside the hollow cylinder 27a. That is, in the rotary screen 27, the hollow cylinder 27a is rotated in accordance with the rotation of the impression cylinder 21e, and special ink or the like, a liquid in the ink fountain 27b, is pushed out through the small holes of the hollow cylinder 27a by the squeegee 27c. Thus, the rotary screen 27 can perform printing, corresponding to the small holes of the hollow cylinder 27a, on the sheet 1 held on the impression cylinder 21e.

As shown in FIG. 1, a transfer cylinder 26e contacts a portion of the impression cylinder 21e of the screen printing unit 20e downstream from the rotary screen 27 in the rotating direction of the impression cylinder 21e. The transfer cylinder 26e has the same prescribed dimensions as the transfer cylinder 26d. Thus, the sheet 1 can be transferred, without problems and without interference, between the impression cylinder 21e of the screen printing unit 20e and the transfer cylinder 26e, as in the relation between the impression cylinder 21e and the transfer cylinder 26d.

A transport cylinder 28 of a drying unit 20f contacts a portion of the transfer cylinder 26e downstream from the impression cylinder 21e in the rotating direction of the transfer cylinder 26e. The transfer cylinder 26e and the transport cylinder 28 are designed such that the sheet 1 can be transferred therebetween without problems. A drying lamp 29 for applying ultraviolet radiation (UV) is disposed along a portion of the transport cylinder 28 downstream from the transfer cylinder 26e in the rotating direction of the transport cylinder 28.

A delivery cylinder 31 of a delivery unit 30 contacts a portion of the transport cylinder 28 of the drying unit 20f downstream from the drying lamp 29 in the rotating direction of the transport cylinder 28. In the delivery cylinder 31, a sprocket 32 is provided so as to be integrally rotatable coaxially with the delivery cylinder 31. A delivery stand 35 is provided in the delivery unit 30. A sprocket 33 is provided above the delivery stand 35. A delivery chain 34 having a plurality of delivery grippers (not shown) attached thereto at predetermined intervals is looped between the sprockets 32 and 33.

The actions of the printing press constituted as described above will be described. Sheets 1 are dispatched one by one from the feeder stand 11 of the feeder unit 10 onto the feeder board 12. The sheet 1 is then transferred by the swing arm shaft pregripper 13 to the impression cylinder 21a of the first offset printing unit 20a of the printing unit 20. Separately, ink and dampening water are supplied to the plate cylinder 23a from the inking device 24a and the dampening device 25a of the first offset printing unit 20a, and supplied from the plate cylinder 23a to the blanket cylinder 22a. The ink is transferred from the blanket cylinder 22a onto the sheet 1, whereby the sheet 1 is printed in a first color. Then, the sheet 1 is passed on to the impression cylinder 21b of the second offset printing unit 20b via the transfer cylinder 26a, whereupon the sheet 1 is printed in a second color in the second offset printing unit 20b in the same manner as in the first offset printing unit 20a. Subsequently, the sheet 1 is printed in a third color and a fourth color in the third and fourth offset printing units 20c and 20d in the same manner as described above.

The sheet 1, which has been printed in the fourth color in the fourth offset printing unit 20d, is passed on to the transfer cylinder 26d from the impression cylinder 21d. At this time, a larger gap than usual is formed between the outer peripheral surface of the impression cylinder 21d and the outer peripheral surface of the transfer cylinder 26d. However, the distance between the gripper pad 26da and the cylinder axis, the distance between the gripper holder 26db and the cylinder axis, and the distance between the gripper 26dc and the cylinder axis in the transfer cylinder 26d are the same as those in the other transfer cylinders 26a to 26c of an ordinary size. Thus, the sheet can be passed on to the transfer cylinder 26d from the impression cylinder 21d without problems.

The sheet 1 passed on to the transfer cylinder 26d is transferred to the impression cylinder 21e of the screen printing unit 20e. At this time, the diametrical dimension of the impression cylinder 21e is larger than the ordinary dimension indicated by the two-dot chain lines in FIG. 4. However, the diametrical dimension of the transfer cylinder 26d is smaller than the ordinary dimension, indicated by the two-dot chain lines in FIGS. 4 and 5, in response to the diametrical dimension of the impression cylinder 21e. Also, the distance from the axis to the gripper device in each of the transfer cylinder 26d and the impression cylinder 21e, which comprises the gripper pads 26da, 21ea, gripper holders 26db, 21eb, and grippers 26dc, 21ec, is the same as that in the other cylinders 26a to 26c and 21a to 21d. Thus, the sheet 1 can be transferred from the transfer cylinder 26d to the impression cylinder 21e without problems.

The sheet 1 transferred to the impression cylinder 21e of the screen printing unit 20e is printed with special ink or the like to a large thickness from the rotary screen 27 in the manner described earlier. At this time, the distance between the outer peripheral surface (effective impression area) of the impression cylinder 21e and the axis (accordingly, the diametrical dimension) is set such that when the gripper 21ec is closed (when the gripper 21ec holds the sheet 1), the gripper 21ec is buried inwardly of the outer peripheral surface of the impression cylinder 21e. Thus, the gripper 21ec of the impression cylinder 21e does not interfere with the rotary screen 27.

The sheet 1, printed with special ink or the like to a large thickness, is passed on to the transfer cylinder 26e from the impression cylinder 21e. At this time, the diametrical dimension of the impression cylinder 21e is greater, while the diametrical dimension of the transfer cylinder 26e is smaller like the transfer cylinder 26d. Also, the distance from the axis to the gripper device in each of the transfer cylinder 26e and the impression cylinder 21e is the same as that in the other cylinders 26a to 26d and 21a to 21d. Thus, the sheet 1 can be transferred from the impression cylinder 21e to the transfer cylinder 26e without problems.

The sheet 1 passed on to the transfer cylinder 26e is transferred to the transport cylinder 28 of the drying unit 20f. At this time, a greater gap than usual occurs between the outer peripheral surface of the transfer cylinder 26e and the outer peripheral surface of the transport cylinder 28. However, the distance between the gripper device of the transfer cylinder 26e and the cylinder axis is the same as that in the other transfer cylinders 26a to 26c of an ordinary size. Thus, the sheet 1 can be transferred from the transfer cylinder 26e to the transport cylinder 28 without being pinched between the transfer cylinder 26e and the transport cylinder 28.

The sheet 1, held on the transport cylinder 28 of the drying unit 20f, has the printed special ink or the like dried with ultraviolet radiation from the drying lamp 29. Then, the sheet 1 is passed on to the delivery cylinder 31 of the delivery unit 30, carried via the delivery grippers during traveling movement of the delivery chain 34, and discharged onto the delivery stand 35.

In the foregoing printing press, the distance between the outer peripheral surface (effective impression area) of the impression cylinder 21e of the screen printing unit 20e and the cylinder axis (accordingly, the diametrical dimension) is set such that when the gripper 21ec of the impression cylinder 21e is closed (when the gripper 21ec holds the sheet 1), the gripper 21ec is buried inwardly of the outer peripheral surface of the impression cylinder 21e. Thus, the gripper 21ec of the impression cylinder 21e does not interfere with the rotary screen 27. Consequently, the sheet 1 can be satisfactorily printed with the special ink or the like to a large thickness by the rotary screen 27.

Furthermore, the diametrical dimensions of the transfer cylinders 26d, 26e for transfer of the sheet 1 to and from the impression cylinder 21e of the screen printing unit 20e are set to be small in response to the diametrical dimension of the impression cylinder 21e being set at a large value. Also, the distance between the axis and the gripper device in each of the transfer cylinders 26d and 26e is rendered the same as that in the other transfer cylinders 26a to 26c. Thus, transfer of the sheet 1 between the transfer cylinders 26d, 26e and the impression cylinder 21e can be carried out without problems. Besides, transfer of the sheet 1 can also be performed, without problems, between the transfer cylinders 26d, 26e and the impression cylinder 21d and transport cylinder 28 serving for transfer to and from these cylinders 26d, 26e.

That is, the first to fourth offset printing units 20a to 20d, the screen printing unit 20e, and the delivery unit 30 are connected together uninterruptedly by constituting the impression cylinder 21e of the screen printing unit 20e in the above-described manner, and the transfer cylinders 26d, 26e contacting the impression cylinder 21e in the above-described manner. According to the so constituted printing press, offset printing and screen printing can be performed continuously on the same sheet 1. Thus, transfer of the sheet 1 between offset printing and screen printing, and registration of the sheet 1 in each of these types of printing become unnecessary, so that the operation efficiency can be increased.

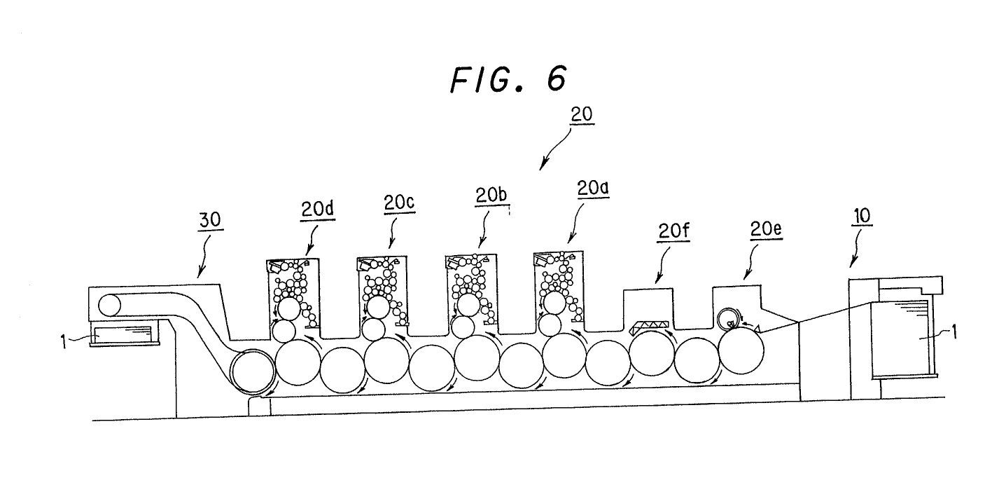

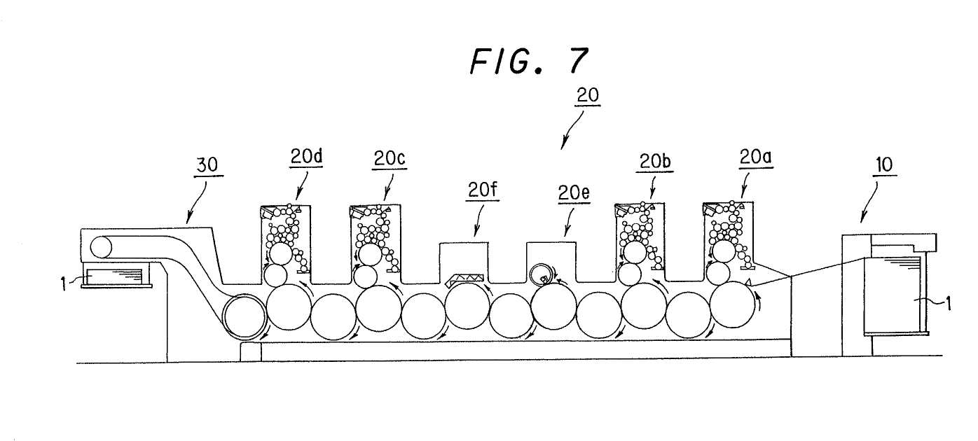

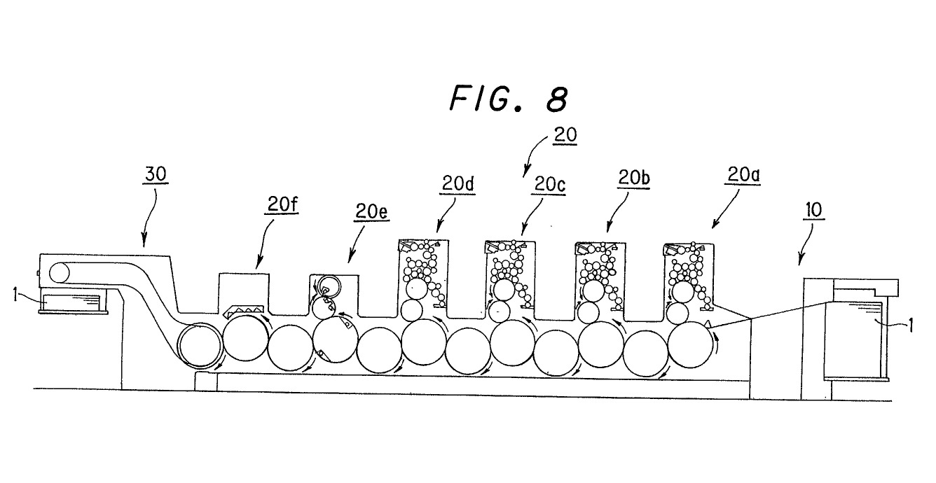

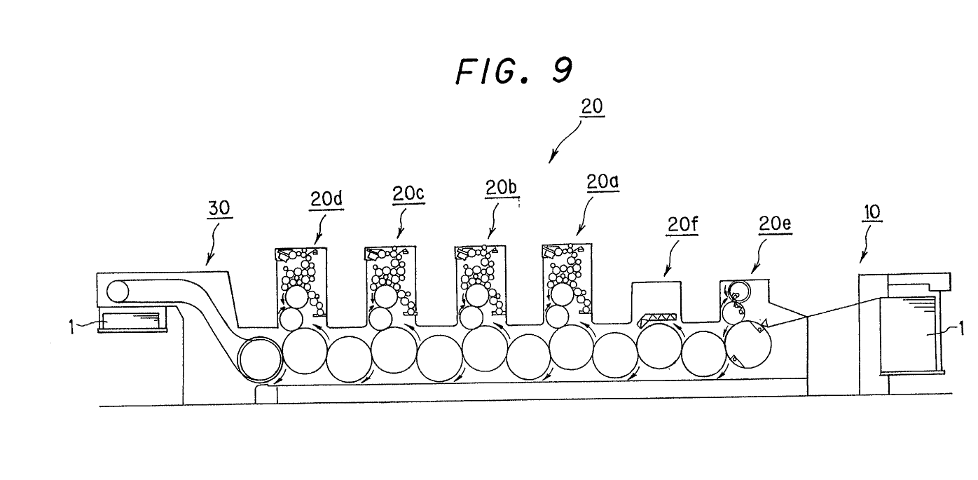

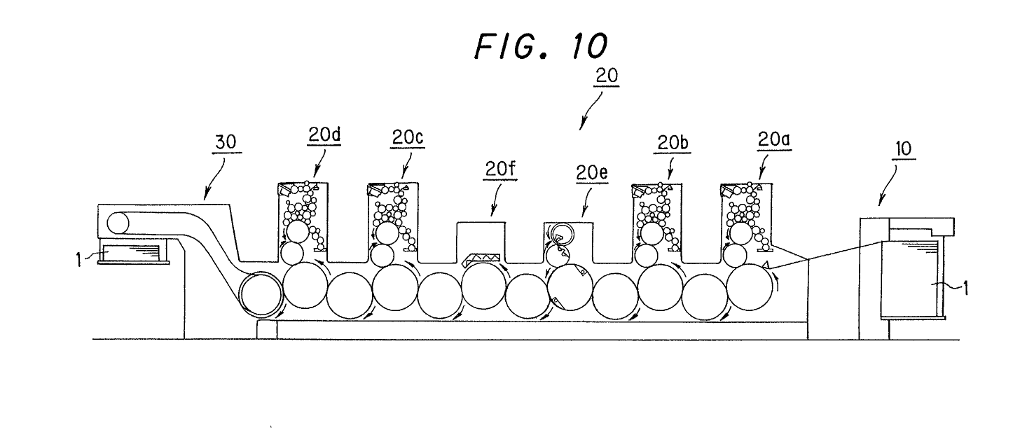

In the present embodiment, the screen printing unit 20e and the drying unit 20f are disposed downstream from the first to fourth offset printing units 20a to 20d. However, the screen printing unit 20e and the drying unit 20f may be disposed upstream from the first to fourth offset printing units 20a to 20d, as shown in FIG. 6. Alternatively, the screen printing unit 20e and the drying unit 20f may be disposed between the first to second offset printing units 20a to 20b and the third to fourth offset printing units 20c to 20d, as shown in FIG. 7. According to the present embodiment, moreover, the rotary screen 27 and the impression cylinder 21e directly contact each other. However, a blanket cylinder 22e maybe interposed between the rotary screen 27 and the impression cylinder 21e, as shown in FIGS. 8 to 10.

[Second Embodiment]

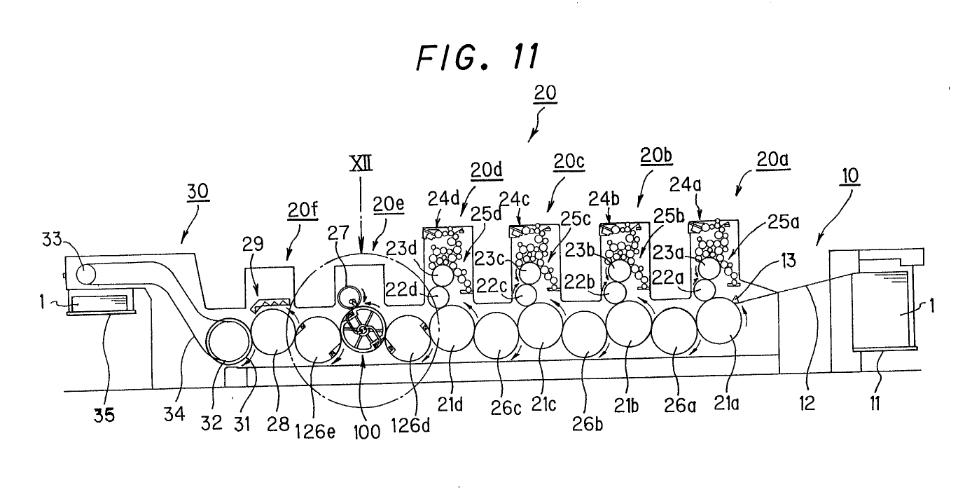

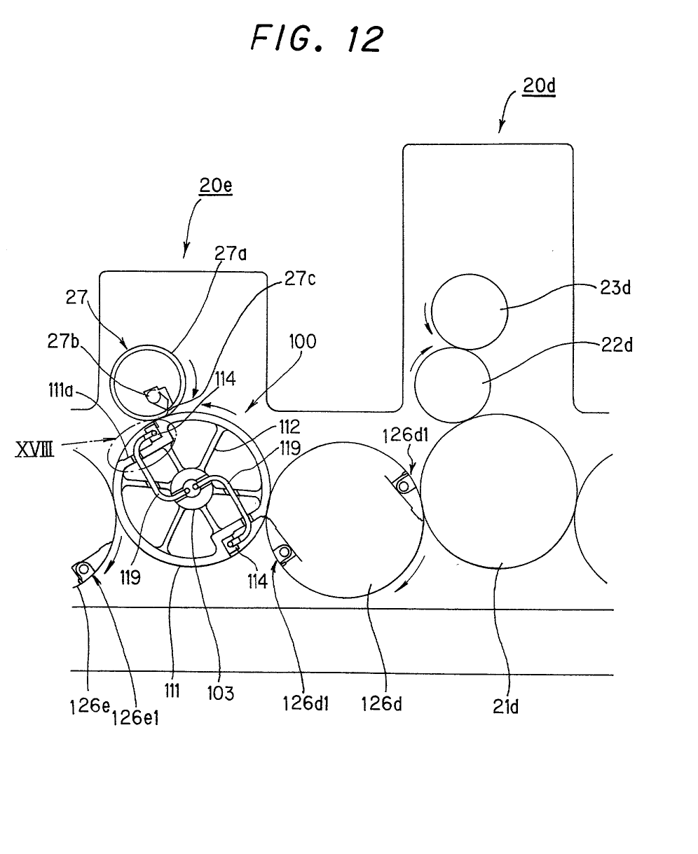

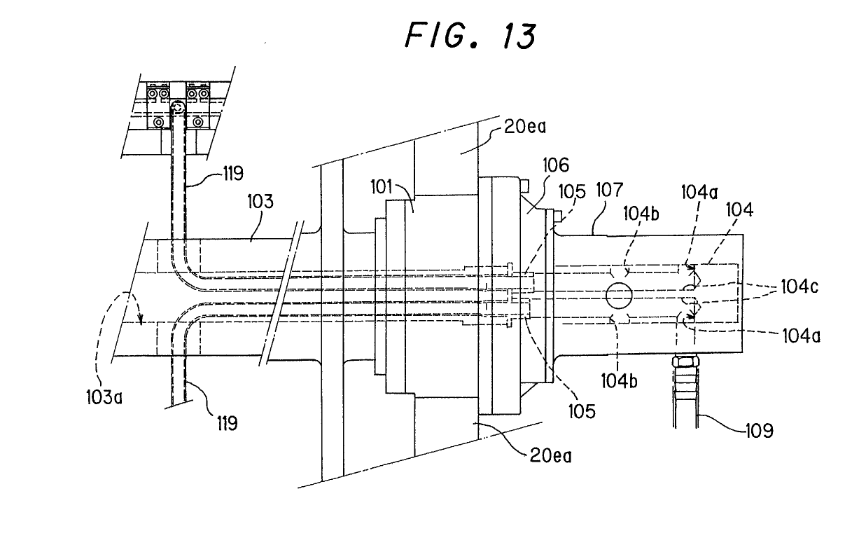

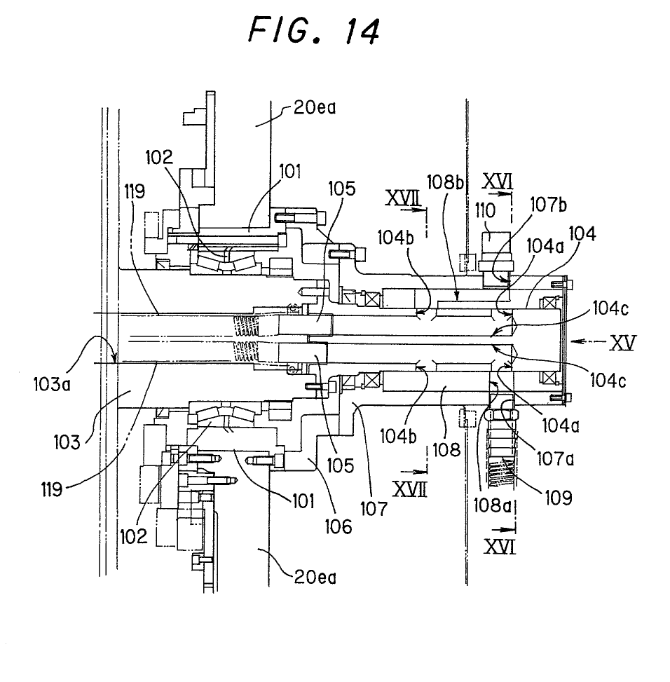

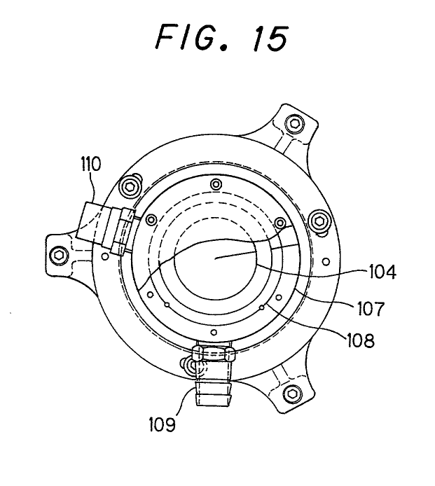

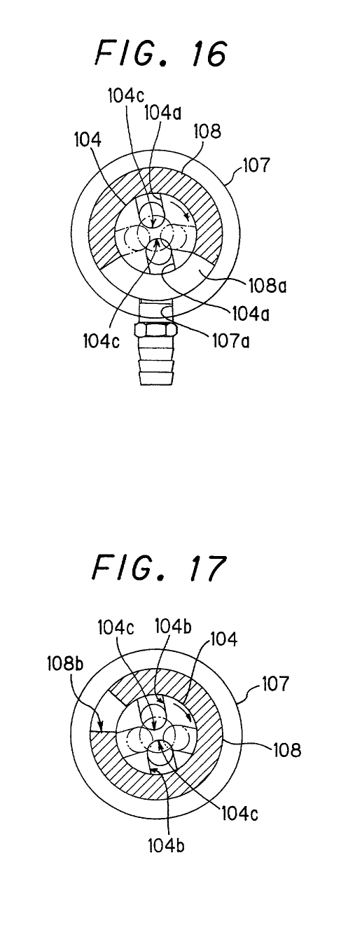

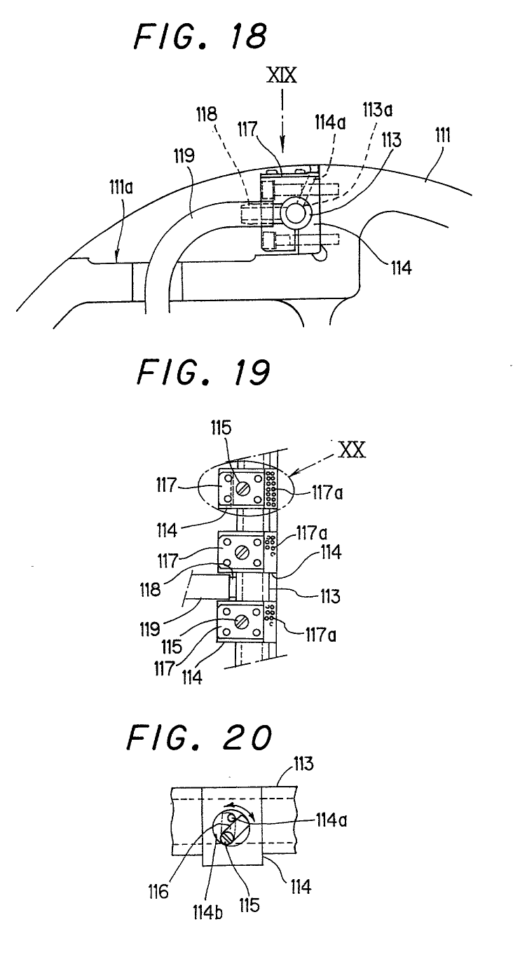

A second embodiment of a printing press according to the present invention will be described using FIGS. 11 to 20. FIG. 11 is an overall schematic configuration view of the printing press. FIG. 12 is an extracted enlarged view of a portion indicated by an arrow XII in FIG. 11. FIG. 13 is an extracted enlarged view of an end portion of a shaft of an impression cylinder of a screen printing unit. FIG. 14 is a sectional view of FIG. 13. FIG. 15 is a view taken from the direction of an arrow XV in FIG. 14. FIG. 16 is a sectional view taken on line XVI-XVI in FIG. 14. FIG. 17 is a sectional view taken on line XVII-XVII in FIG. 14. FIG. 18 is an extracted enlarged view of a portion indicated by an arrow XVIII in FIG. 12. FIG. 19 is a view taken from the direction of an arrow XIX in FIG. 18. FIG. 20 is an internal structure view of a portion indicated by an arrow XX in FIG. 19. In these drawings, the same portions as in the aforementioned First Embodiment will be assigned the same numerals as used in the descriptions of the First Embodiment, and their explanations will be omitted.

As shown in FIGS. 11 and 12, a transfer cylinder 126d having the same prescribed dimensions as the aforementioned transfer cylinders 26a to 26c contacts a portion of an impression cylinder 21d of a fourth offset printing unit 20d downstream from a blanket cylinder 22d in the rotating direction of the impression cylinder 21d. An impression cylinder 100 of a screen printing unit 20e contacts the transfer cylinder 126d. The impression cylinder 100 has a structure as described below.

As shown in FIGS. 13 and 14, an end portion of a rotary shaft 103 is rotatably supported by a frame 20ea of the screen printing unit 20e via a locking ring 101 and a bearing 102. Inside the rotary shaft 103, a communication hole 103a is formed along an axial direction. To a shaft end of the rotary shaft 103, a connecting shaft 104 is attached coaxially. Inside the connecting shaft 104, a plurality of (two in the present embodiment) communication holes 104c are formed along the axial direction. The communication hole 104c is connected at one end to the interior of the communication hole 103a of the rotary shaft 103 via a pipe 105, and is closed at the other end.

Near the other end of an outer peripheral surface of the connecting shaft 104, a coupling hole 104a connected to the communication hole 104c is formed at a prescribed position in a circumferential direction of the connecting shaft 104. Near one end of the outer peripheral surface of the connecting shaft 104, a coupling hole 104b connected to the communication hole 104c is formed at a prescribed position in the circumferential direction of the connecting shaft 104 (see FIGS. 16 and 17).

To an end portion of the locking ring 101 beside the connecting shaft 104, one end portion of an outer tube 107 surrounding the connecting shaft 104 is connected and fixed via a connecting implement 106 coaxially with the connecting shaft 104. In a peripheral surface of the outer tube 107, coupling holes 107a, 107b for ensuring communication between the inside and the outside of the outer tube 107 are formed at prescribed positions in a circumferential direction of the outer tube 107 (see FIGS. 14 and 15).

Between the outer tube 107 and the connecting shaft 104, a sleeve 108 is inserted coaxially with the connecting shaft 104 and the outer tube 107. The sleeve 108 is fixed to and supported by the outer tube 107, and supports the connecting shaft 104 rotatably. In a peripheral surface of the sleeve 108, a coupling groove 108a and a coupling groove 108b are formed with predetermined lengths at prescribed positions in a circumferential direction of the sleeve 108 (see FIGS. 14, 16 and 17). The coupling groove 108a couples the coupling hole 104a of the connecting shaft 104 to the coupling hole 107a of the outer tube 107 with a prescribed cycle in accordance with the rotation of the connecting shaft 104. Similarly, the coupling groove 108b couples the coupling hole 104b of the connecting shaft 104 to the coupling hole 107b of the outer tube 107 with a prescribed cycle in accordance with the rotation of the connecting shaft 104.

To the coupling hole 107a of the outer tube 107, a suction pump (not shown) is coupled via a hose 109. To the coupling hole 107b of the outer tube 107, an air muffler 110 is coupled. That is, when the rotary shaft 103 is rotated to rotate the connecting shaft 104 and the suction pump is actuated, the communication holes 104c of the connecting shaft 104 communicate with the coupling grooves 108a of the sleeve 108 via the coupling hole 104a with the prescribed cycle, and communicate with the suction pump via the coupling hole 107a of the outer tube 107, whereby air inside them is sucked. On the other hand, the communication holes 104c communicate with the coupling groove 108b of the sleeve 108 via the coupling hole 104b with the prescribed cycle, and communicate with the air muffler 110 via the coupling hole 107b of the outer tube 107, whereby the pressure inside them is returned to the outside air pressure.

As shown in FIGS. 12 and 18, a cylinder body 111 is integrally connected to and supported by the rotary shaft 103 via spokes 112 coaxially with the rotary shaft 103. In an outer peripheral surface of the cylinder body 111, a plurality of (two in the present embodiment) gaps 111a extending along an axial direction of the cylinder body 111 are formed at equal intervals along a circumferential direction of the cylinder body 111.

As shown in FIGS. 18 to 20, a piping 113 having a plurality of communication holes 113a (holes for communication between the inside and the outside) formed with predetermined spacing along an axial direction in a peripheral surface of the piping 113 is mounted in the gap 111a of the cylinder body 111 so as to have its axial direction heading along the axial direction of the cylinder body 111. A holder 114 is mounted to the site of the communication hole 113a of the piping 113. A circular mounting groove 114b is formed on the upper surface of the holder 114. A communication hole 114a communicating with the communication hole 113a of the piping 113 is formed in the mounting groove 114b of the holder 114. An opening/closing plate 116 for opening and closing the communication hole 114a upon rotation of a screw 115 is provided in the mounting groove 114b of the holder 114. A head 117, which is a suction holding implement of a plate shape having a hole for allowing the head of the screw 115 to protrude therethrough, is mounted on an upper portion of the holder 114. A suction port 117a communicating with the communication hole 114a of the holder 114 is formed on the upper surface of the head 117.

As shown in FIGS. 18 and 19, one end portion of a pipe 118 is coupled to a peripheral surface of the piping 113. One end portion of a hose 119 is coupled to the other end portion of the pipe 118. The other end portion of the hose 119 is inserted into the communication hole 103a of the rotary shaft 103, and connected to the pipe 105 (see FIGS. 12 to 14).

In detail, when the rotary shaft 103 is rotated to rotate the connecting shaft 104 and the suction pump is actuated, the interior of the piping 113 coupled via the pipe 105, hose 119 and pipe 118 is sucked from the communication hole 104c which communicates with the coupling hole 104a of the connecting shaft 104, when the coupling hole 104a communicates with the coupling groove 108a of the sleeve 108. Then, air is sucked from the suction port 117a of the head 117 through the communication hole 113a of the piping 113 and the communication hole 114a of the holder 114. Furthermore, when the coupling hole 104b of the connecting shaft 104 communicates with the coupling groove 108b of the sleeve 108, the communication hole 104c communicating with the coupling hole 104b communicates with the interior of the piping 113 connected via the pipe 105, hose 119 and pipe 118. As a result, the suction port 117a of the head 117 and the air muffler 110 enter into communication via the communication hole 113a of the piping 113 and the communication hole 114a of the holder 114. Consequently, the portion between the suction port 117a and the air muffler 110 is returned to the atmospheric pressure. Further, when the screw 115 is rotated to open and close the communication hole 114a of the holder 114 with the opening/closing plate 116, the suction port 117a of the head 117 can be opened and closed individually. Thus, regardless of whether the coupling hole 104a of the connecting shaft 104 and the coupling groove 108a of the sleeve 108 are coupled together or not, suction of air from the suction port 117a of the head 117 can be set for each head 117.

In the present embodiment, the connecting shaft 104, outer tube 107, and sleeve 108 constitute switching means; the pipes 105, 118, hoses 109, 119, piping 113 and suction pump constitute suction means; the holder 114, screw 115 and opening/closing plate 116 constitute opening/closing means; and the switching means, suction means, opening/closing means, and head 117 (suction holding implement) constitute suction holding means as sheet-like material holding means.

As shown in FIGS. 11 and 12, a rotary screen 27 contacts a portion of the impression cylinder 100 of the screen printing unit 20e downstream from the transfer cylinder 126d in the rotating direction of the impression cylinder 100. A transfer cylinder 126e of the same prescribed size as the transfer cylinders 26a to 26c contacts a portion of the impression cylinder 100 of the screen printing unit 20e downstream from the rotary screen 27 in the rotating direction of the impression cylinder 100.

In the so constituted printing press, when a gripper device 126d1 of the transfer cylinder 126d having received the sheet 1 approaches the head 117 of the impression cylinder 100 of the screen printing unit 20e, the coupling hole 104b of the connecting shaft 104 communicating with the suction port 117a of the head 117 leaves the coupling groove 108b of the sleeve 108. Thus, the communication between the air muffler 110 and the communication hole 104c of the connecting shaft 104 is cut off. Also, the coupling hole 104a of the connecting shaft 104 communicating with the suction port 117a of the head 117 enters into communication with the coupling groove 108a of the sleeve 108. By the action of the suction pump, air is sucked from the suction port 117a of the head 117. At the same time, the gripper device 126d1 of the transfer cylinder 126d releases a grip on the sheet 1. Hence, the sheet 1 is sucked to and held by the head 117 of the impression cylinder 100, and passed from the transfer cylinder 126d on to the impression cylinder 100.

The sheet 1 transferred to the impression cylinder 100 of the screen printing unit 20e is printed with special ink or the like to a large thickness from the rotary screen 27 in the same manner as in the aforementioned embodiment. On this occasion, the impression cylinder 100 holds the sheet 1 by the suction force of the head 117, and lacks a member (such as a gripper) protruding from the surface of the cylinder body 111. Thus, the impression cylinder 100 does not interfere with the rotary screen 27.

After thick printing on the sheet 1 by the rotary screen 27, the head 117 of the impression cylinder 100 approaches a gripper device 126e1 of the transfer cylinder 126e. At this time, the gripper device 126e1 of the transfer cylinder 126e grips the sheet 1, and the coupling hole 104a of the connecting shaft 104 in communication with the suction port 117a of the head 117 leaves the coupling groove 108a of the sleeve 108. Thus, the communication with the suction pump is cut off, and suction of air from the suction port 117a of the head 117 is stopped. Also, the coupling hole 104b of the connecting shaft 104 in communication with the suction port 117a of the head 117 communicates with the coupling groove 108b of the sleeve 108. As a result, the portion between the air muffler 110 and the suction port 117a of the head 117 is returned to the atmospheric pressure. Thus, the sheet 1 is released from suction holding by the head 117 of the impression cylinder 100, and is passed from the impression cylinder 100 on to the transfer cylinder 126e.

That is, according to the present embodiment, the first to fourth offset printing units 20a to 20d, the screen printing unit 20e, and the delivery unit 30 can be connected together uninterruptedly by constituting the impression cylinder 100 of the screen printing unit 20e in the above-described manner. In the above-described printing press, the impression cylinder 100 of the screen printing unit 20e does not interfere with the rotary screen 27 or the transfer cylinders 126d, 126e. Hence, thick printing with special ink or the like by the rotary screen 27, and transfer of the sheet 1 from and to the transfer cylinders 126d and 126e can be performed without problems. According to the so constituted printing press, therefore, offset printing and screen printing can be performed continuously on the same sheet 1 in the same manner as in the aforementioned First Embodiment. Thus, transfer of the sheet 1 between offset printing and screen printing, and registration of the sheet 1 in each of these types of printing become unnecessary, so that the operation efficiency can be increased. Furthermore, if any one of all heads 117 takes no part in the attraction and holding of the sheet 1 depending on the size in the width direction of the sheet 1, the screw 115 of the head 117 that plays no role in the attraction and holding of the sheet 1 is rotated to close the suction port 117a of the head 117 with the opening/closing plate 116. By so doing, the suction force can be increased without waste of suction by the suction pump.

In the present embodiment, each of the opening/closing plates 116 in the mounting grooves 114a of the holders 114 provided in the gap 111a of the cylinder body 111 of the impression cylinder 100 is turned by the screw 115, whereby the suction range corresponding to the size of the sheet 1 is set. Instead of the opening/closing plate 116, screw 115, etc., the other end portion of the hose 119 may be bifurcated and directly connected to the holder 114, and opening/closing valves may be provided at the branches of the bifurcated end portion of the hose 119. By so doing, the presence or absence of suction through the head 117 can be set. If it is designed that the presence or absence of suction through the heads 117, which are located at an equal distance from the center in the width direction of the sheet 1, can be set by the same opening/closing valve, time and effort taken for setting can be halved.

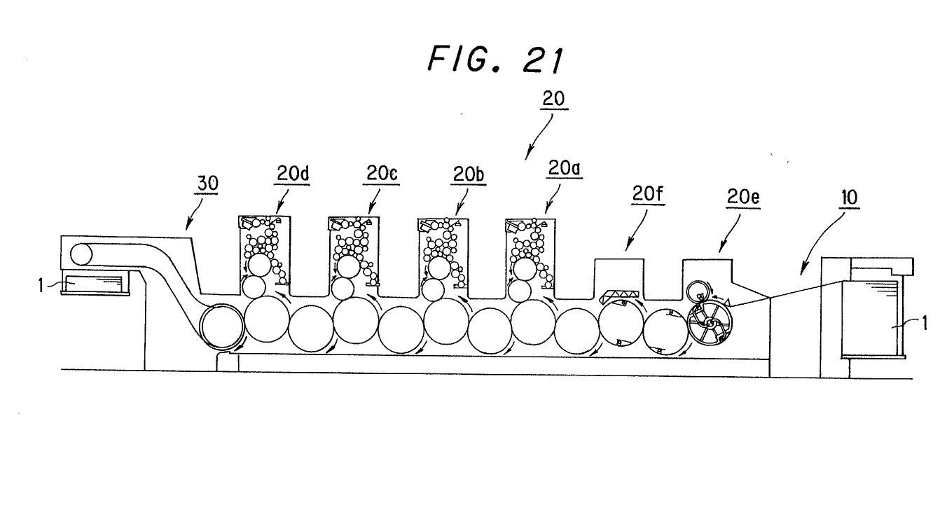

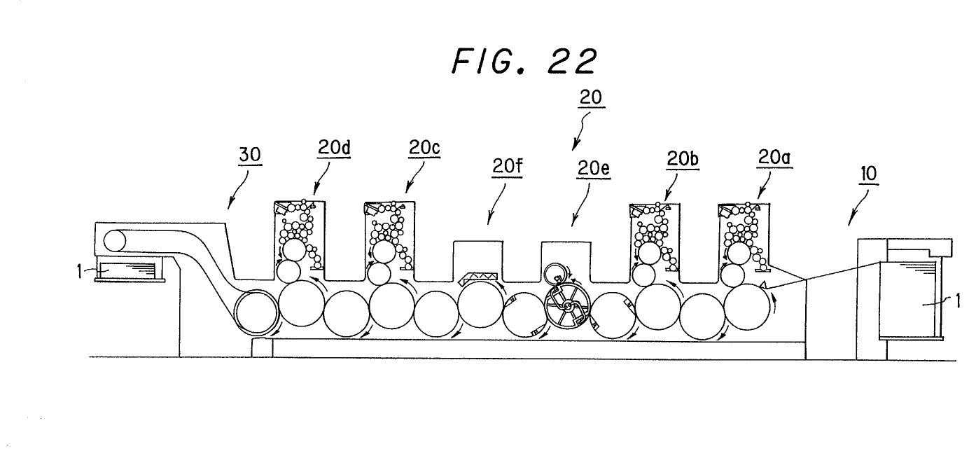

In the present embodiment, moreover, the screen printing unit 20e and the drying unit 20f are disposed downstream from the first to fourth offset printing units 20a to 20d. However, the screen printing unit 20e and the drying unit 20f may be disposed upstream from the first to fourth offset printing units 20a to 20d, as shown in FIG. 21. Alternatively, the screen printing unit 20e and the drying unit 20f may be disposed between the first to second offset printing units 20a to 20b and the third to fourth offset printing units 20c to 20d, as shown in FIG. 22.

In the aforementioned first and second embodiments, the printing press, having only the offset printing units 20a to 20d and screen printing unit 20e connected together uninterruptedly, is described. In this printing press, a gravure printing unit and a flexographic printing unit may be further connected to these printing units.

While the present invention has been described in the foregoing fashion, it is to be understood that the invention is not limited thereby, but may be varied in many other ways. Such variations are not to be regarded as a departure from the spirit and scope of the invention, and all such modifications as would be obvious to one skilled in the art are intended to be included within the scope of the appended claims.

What is claimed is:

1. A printing press comprising:
an offset rotary printing unit for offset printing a sheet-like material; and
a rotary screen printing unit for screen printing said sheet-like material, and wherein said offset rotary printing unit and said rotary
screen printing unit are connected together so that offset printing and screen printing can be continuously performed on said same sheet-like material.

2. The printing press of claim 1, wherein
said rotary screen printing unit includes
a rotatable impression cylinder having a gripper for holding said sheet-like material, and
a rotatable rotary screen contacting said impression cylinder for screen printing said sheet-like material held on said impression cylinder,
a rotatable transfer cylinder connects said impression cylinder of said rotary screen printing unit to said offset rotary printing unit,
a diametrical dimension of said impression cylinder of said rotary screen printing unit is set such that said gripper of said impression cylinder is buried inwardly of an outer peripheral surface of said impression cylinder when said gripper holds said sheet-like material, and
a diametrical dimension of said transfer cylinder is set such that said sheet-like material can be transferred between said impression cylinder of said rotary screen printing unit and said offset rotary printing unit.

3. The printing press of claim 1, wherein
said rotary screen printing unit includes
a rotatable impression cylinder having sheet-like material holding means for holding said sheet-like material, and
a rotary screen contacting said impression cylinder for screen printing said sheet-like material held on said impression cylinder, and
said sheet-like material holding means of said impression cylinder of said rotary screen printing unit comprises suction holding means for sucking and holding said sheet-like material.

4. The printing press of claim 3, wherein
said suction holding means includes
a suction holding implement provided in a gap of an outer peripheral surface of said impression cylinder, and having a suction port on a surface of said suction holding implement,
suction means connected to said suction holding implement, and
switching means provided between said suction holding implement and said suction means and adapted to establish communication between said suction holding implement and said suction means when receiving said sheet-like material and block communication between said suction holding implement and said suction means when transferring said sheet-like material.

5. The printing press of claim 4, wherein
a plurality of said suction holding implements are provided along an axial direction of said impression cylinder, and
opening/closing means for opening and closing said suction port of said suction holding implement is provided for each of said suction holding implements.
